(19) United States
(12) Patent Application Publication
(10) Pub. No.: US 2024/0192169 A1
(43) Pub. Date: Jun. 13, 2024

(54) ELECTROCHEMICAL METHOD AND SYSTEM FOR THE INDIRECT MONITORING OF SCALE INHIBITORS IN ONSHORE AND OFFSHORE INSTALLATIONS

(71) Applicants: PETRÓLEO BRASILEIRO S.A. – PETROBRAS, Rio de Janeiro (BR); CNPEM - CENTRO NACIONAL DE PESQUISA EM ENERGIA E MATERIAIS, Campinas (BR)

(72) Inventors: Anielli Martini PASQUALETI, Campinas (BR); Renato Sousa LIMA, Campinas (BR); Maria Helena De Oliveira PIAZZETTA, Campinas (BR); Angelo Luiz GOBBI, Campinas (BR); Flavio Makoto SHIMIZU, Campinas (BR); Rogerio MESQUITA DE CARVALHO, Rio de Janeiro (BR)

(21) Appl. No.: 18/533,391

(22) Filed: Dec. 8, 2023

(30) Foreign Application Priority Data
Dec. 13, 2022 (BR) 1020220254575

(51) Int. Cl. G01N 27/48; G01N 27/30

(52) U.S. Cl. CPC G01N 27/48; G01N 27/30; F17D 3/12

(57) ABSTRACT

The present disclosure refers to an electrochemical method for the indirect monitoring of the concentration of the active matter of scale inhibitors, composed of phosphonates, based on principles of advanced oxidative processes, which is viable for quality control of scale inhibitors in onshore and offshore installations. Additionally, the present disclosure refers to an electrochemical system for the indirect monitoring of the concentration of the active matter of scale inhibitors in onshore and offshore installations.

### FIELD OF THE DISCLOSURE

The present disclosure is preferably inserted in the field of offshore and onshore oil platforms to determine the concentration of the active matter (specifically phosphonate) of scale inhibitors, thus making it possible to determine the quality of the inhibitor received by the oil and gas industry. This analysis will enable rapid decision-making to readjust the dose of inhibitor to be applied or corrected in the production lines. Additionally, the proposed method and system are not limited only to the quality of the scale inhibitors, but can also be applied to the determination of phosphorus residuals in production water. And, finally, the described approach can be applied to the quality control of phosphorus chemical products, both from the point of view of process control and mainly when receiving/dispatching products for offshore shipping.

### BACKGROUNDS OF THE DISCLOSURE

The scale formation processes are one of the biggest problems faced by the oil and gas industry, which can result in economic loss, personnel risks and environmental damage. To minimize such impacts, efforts have been directed towards the development of scale management and control programs, which include mechanical and chemical approaches. The latter is more interesting, as there is a wide range of scale inhibitors to partially prevent or reduce the formation of scale by inhibiting the nucleation on surfaces and/or the growth of salt crystals in pipes, valves and pumps.

Knowledge of the concentration of the active matter of the inhibitors can be crucial for a long and effective treatment to prevent or reduce scale. Although companies supplying chemical products generally provide information regarding concentration ranges, it is known that process control is not effective enough to avoid variations in the concentration of the active matter. Mixture instability problems associated with incorrect packaging (open environments and long storage times) contribute to variations in product concentration, thus highlighting the importance of quality control of inhibitors before their application in production lines, to guarantee flow, avoiding problems that could lead to production stoppage for maintenance, or even partial/total blockage of wells of oil. Additionally, the inhibitors containing phosphorus require extra attention, as an excess of this element in water bodies can trigger eutrophication, leading to a negative impact on aquatic ecosystems.

The conventional analytical methods used to quantify the chemical inputs are based on wet chemical analysis, using methods such as phosphomolybdenum blue and hyamine and fluorescence and time-resolved fluorescence techniques; inductively coupled plasma optical emission spectrometry (ICP-OES), inductively coupled plasma mass spectrometry (ICP-MS), ion chromatography, high performance liquid chromatography (HPLC) and mass spectrometry (MS). Interferents, sample preparation conditions, matrix effects (salinity, for example) and origin of the samples can be factors that make an assertive analysis difficult. Furthermore, all methods require a laboratory, require time and, in some cases, specialized personnel and controlled rooms to accommodate large and expensive equipment, making their use for in loco monitoring unfeasible. Little is reported about the quality control of scale inhibitors, that is, the characterization of these inhibitors before they are injected into oil and gas production lines. The same techniques mentioned above can be used for the prior characterization of inhibitors; however, the same disadvantages remain, making decision-making and action difficult for operators in oil and gas production.

As a solution to many of these problems, the use of an electrochemical method is proposed, due to its low cost, high sensitivity and selectivity and portability. In this sense, the objective was to develop an electrochemical method and system for the indirect monitoring of scale inhibitors, composed exclusively of phosphonates, based on principles of oxidative methods (exposing samples to UV light in the presence of a strong oxidant), which is viable for quality control of scale inhibitors in onshore and offshore installations. The expression ‘indirect phosphonate monitoring’ was used, since the developed method is applied to phosphate detection. Thus, the phosphonate species were first converted into phosphate through a process assisted by UV light in the presence of a strong oxidant and, as the phosphate groups are not electroactive, it was necessary to complex them with molybdate ions, forming the phosphomolybdenum complex, called Keggin anion, which was electrochemically detected.

The proposed system consists of a UV lamp, a small and portable set of electrodes (with areas delimited by a layer of epoxy resin) and a potentiostat, which is controlled by a computer, but can also be controlled by cell phones or other technologies on the market. Therefore, a lower investment is required when compared to the costs of purchasing, maintaining and storing analytical equipment used for the characterization of scale inhibitors. The method requires sample preparation, but does not require laboratory conditions and does not require large sample volumes, enabling the operator to prepare and analyze samples in loco, which reduces the time to obtain results and facilitates decision making in terms of the volumes of inhibitors to be injected into the production lines. Therefore, the method can be an important tool for managing inputs and ensuring flow in the oil and gas industry.

### State of the Art

In the document Jońca et al., 2011, titled “Phosphate determination in seawater: Toward an autonomous electrochemical method”, initial steps are presented to create in situ an autonomous electrochemical sensor for determining phosphate in seawater. Firstly, the optimal conditions for forming the phosphomolybdenum complex in an artificial seawater medium were determined by adding sulfuric acid and sodium molybdate to the phosphate-containing solution. Secondly, the anodic oxidation of molybdenum to form molybdate ions and protons was used to create the phosphomolybdenum complex without adding liquid reagents. The phosphomolybdenum complex is detectable by amperometry with an average precision of 2.2% for the concentration range found in the open sea and the detection limit is 0.12 μmol L⁻¹. The results showed good precision with an average of 2.5% and a reasonable deviation of the amperometric analysis in relation to the colorimetric measurements (4.9%).

The document Jońca et al., 2013, titled “In Situ Phosphate Monitoring in Seawater: Today and Tomorrow”, refers to the determination of phosphate in seawater. Thus, the sources, occurrence and importance of phosphate are briefly described along with various aspects relating to the analysis and terminology used to determine this element in the ocean. Existing and future in situ analytical techniques for the determination of phosphate in seawater are presented. In situ phosphate monitoring today is dominated by different spectrophotometric analyzers. Thus, a description of the basis, advantages and disadvantages of the different existing analyzers is provided. It is concluded that such techniques can be replaced in the near future by electrochemical sensors that offer excellent possibilities for determining phosphate with high precision, long useful life, low detection limit, good reproducibility and mainly because they do not suffer variation effects of index of refraction and turbidity of the aqueous matrices, which represents an advantage of the method, as shown in works found in the literature that evaluated seawater samples. Furthermore, electrochemistry allows to go further in miniaturization, reduces energy requirements and avoids additional reagents.

The document Quintana et al., 2004, titled “Investigation of amperometric detection of phosphate Application in seawater and cyanobacterial biofilm samples”, refers to the construction and use of an amperometric sensor for phosphate detection. The phosphomolybdenum complex, formed by the addition of nitric acid, ammonium molybdate and phosphate, was reduced on a polarized carbon paste electrode at +0.3 V (versus Ag/AgCl). The main features observed were simplicity of the equipment, limited reagent consumption and low detection limit (0.3 μmol L⁻¹), with a linear range between 1 and 20 μmol L⁻¹. Silicate interference was completely eliminated using a suitable concentration of nitric acid and ammonium molybdate. Amperometric detection of phosphate in seawater using batch injection analysis (BIA) technique has been reported. Furthermore, a carbon paste microelectrode was constructed. Its use allows the analysis of small volumes of samples with little dilution in supporting electrolyte.

The document Udnan et al., 2005, titled “Evaluation of on-line preconcentration and flow-injection amperometry for phosphate determination in fresh and marine waters”, refers to the determination of dissolved reactive phosphorus (PRD) as phosphate in fresh and saline water samples by flow injection amperometry (FI), without and with pre-concentration in an ion exchange column. The detection is based on the reduction of the product formed from the reaction of PRD with acidic molybdate on a glassy carbon working electrode (GCE) at 220 mV versus the Ag/AgCl reference electrode. A 0.1 mol L⁻¹ potassium chloride solution was used as supporting electrolyte and eluent in the preconcentration system. For the FI configuration without preconcentration, a detection limit of 3.4 μg P L⁻¹ and a sample yield of 70 samples h⁻¹ were achieved. The relative standard deviations for 50 and 500 g P L⁻¹ phosphate standards were 5.2 and 5.9%, respectively. By incorporating an ion exchange preconcentration column, a detection limit of 0.18 μg P L⁻¹ was obtained for a preconcentration time of 2 min (relative standard deviations for standards of 0.1 and 1 μg P L⁻¹ were 22 and 1.0%, respectively). Potential interferents such as silicate, sulfide, organic phosphates and sodium chloride were investigated. Both systems have been applied to the analysis of certified reference materials and water samples.

The document Kolliopoulos et al., 2015, titled “Rapid and Portable Electrochemical Quantification of Phosphorus”, proposes the use of disposable carbon printed electrodes for the detection of total phosphorus from aqueous samples from the Manchester city canal using voltammetric methods. Before the electrochemical measurements, all forms of phosphorus present in the samples were converted to phosphates through digestion of the sample with persulfate (heating and acidification) following a colorimetric method established by the Environmental Protection Agency (EPA). The sample preparation time determined by EPA requires at least 2 hours, as there are two steps, heating the sample for 30 to 40 minutes, plus the time required to return to room temperature, and this process is repeated for another turn. The phosphorus detection was carried out by cyclic voltammetry experiments in a concentration range between 0 and 20 μg L⁻¹, generating a detection limit of 0.3 μg L⁻¹ of phosphorus.

The document Barus et al., 2016, titled “Toward an in situ phosphate sensor in sea water using Square Wave Voltammetry”, uses square wave voltammetry for in situ detection of phosphate in synthetic seawater samples (via formation of the phosphomolybdenum complex), using an open cell and two laboratory prototypes. In this case, they use gold discs as a working electrode, which is initially polished with aluminum oxide (0.3 μm) and then electrochemically cleaned in a 0.5 mol L⁻¹ solution of sulfuric acid by cyclic voltammetry until the cycles stabilize. Before each electrochemical measurement for phosphate detection, 10 cyclic voltammograms are collected in sodium chloride solution or artificial seawater. The generation of molybdate and protons, necessary for the formation of the complex, occurs in situ from the oxidation of molybdenum electrodes under an applied voltage of 2 V. As in the work of Jońca et al. 2011, there are eliminated the need of adding molybdate and acid, essential for the formation of the complex and, consequent electrochemical monitoring, which can be automated, guaranteeing autonomous monitoring of phosphate in seawater. Two new prototypes were developed, which allowed the detection of phosphate with a sample volume of the order of 400 μL, with detection limits of 0.05 μmol L⁻¹ for high frequency (f=250 Hz) (linear range between 0.1 and 1 μmol L⁻¹, requiring a wait of 60 min for the formation of the phosphomolybdenum complex) and 0.1 μmol L⁻¹ for low frequency (f=2.5 Hz), allowing the linear detection range to be increased to 0.25 to 4 μmol L⁻¹ and reduce the time required for complex formation to 30 min. By coupling the two prototypes, it was possible to reduce this time to 5 min.

The document Wang et al., 2019, titled “Degradation of nitrilotris-methylenephosphonic acid (NTMP) antiscalant via persulfate photolysis: Implications on desalination concentrate treatment”, shows the investigation of the degradation kinetics of a phosphonate molecule, the acid nitrilotris-methylenephosphonic acid (NTMP), widely used as a scale inhibitor in reverse osmosis desalination processes. The UV/persulfate photolysis degradation method proved to be superior and less expensive than the Fenton process, based on UV/hydrogen peroxide, under the same experimental conditions. In this study, after 120 minutes of reaction, only 80% of the NTMP molecule was degraded to phosphate in aqueous solution, whereas in wastewater (brine) the rate dropped to 40%. This application is important for the reuse and desalination of wastewater, as the presence of phosphonate-based inhibitors interfere with mineral precipitation and negatively affects the water recovery process.

Regarding the documents of the state of the art, there is no description of the combined use of the photolysis conversion step (UV/persulfate), of the phosphonate species of “scale inhibitors” to phosphate, with electrochemical reading. Therefore, it does not allow direct application in the analysis of determining the content of active matter in the product and phosphorus residuals in production water.

In the document Kolliopoulos et al., 2015, the water samples from the canal were digested via heating in accordance with the optical protocol recommended by the EPA, a step that requires at least 2 hours to prepare the sample for electrochemical analysis. The present disclosure makes use of advanced oxidative processes, assisted by UV light, which reduced sample preparation time to just minutes (3-15 min).

In the document Wang et al., 2019, the photolysis process, that is, conversion of phosphonate molecules to phosphate using UV light and a strong oxidant, achieved a conversion efficiency of only 40% for brine solution and 80% for pure water for a reaction time of 120 min. In the present disclosure, a conversion efficiency of approximately 100% was obtained for times less than 15 min depending on the power of UV light used in the conversion process.

Considering the step of determining only phosphate, in Jońca et al., 2011, the measurement system itself is basically commercial. In addition, there is a need to generate the molybdate anion in the medium, as a way of allowing in situ analysis. This type of approach is taken into consideration in Jońca et al., 2013 and Barus et al., 2016, given the importance of measuring phosphate at sea (at different depths). In the case of Quintana et al., 2004, the approach used was a cell called BIA (batch in analysis) with a carbon paste electrode. In Udnan et al., 2005, the concept of FIA (flow injection analysis) and glassy carbon electrode are worked with. These alternative techniques, described mainly in Quintana et al., 2004 and Udnan et al., 2005, are used with the aim of reducing the limit of quantification.

In the present disclosure, unlike the aforementioned documents, the working electrode was manufactured by photolithography, can be disposable, does not require polishing, cleaning or conditioning steps before each measurement. It should be noted that the delimitation of the electrode areas by the photolithographic method using epoxy resins (preferably SU-8, but not limited to this resin) increased the reproducibility of measurements between electrodes. The phosphonate-phosphate conversion process, conventionally carried out using traditional digestion techniques, requires laborious sample preparation, generally requiring hours of reaction, along with bench equipment (autoclave, hot plate, etc.). The sample preparation described in this disclosure is assisted by a strong oxidant and a UV light source, which allows phosphonate to be converted to phosphate in a matter of minutes (3 to 15 min), as it was designed with a focus on simplicity and portability, since that the main application also includes analysis in an offshore environment, in combination with electrochemical detection to indirectly quantify the phosphonate in scale inhibitors that, to our knowledge, is described for the first time in the literature. In addition, the detection limit obtained is more than sufficient given the focus of analyzing the active matter content to determine the quality of scale inhibitor products and phosphorus residuals in production water.

### SUMMARY OF THE DISCLOSURE

The present disclosure aims at proposing an electrochemical method for the indirect monitoring of the active matter of scale inhibitors, composed of phosphonates, based on principles of advanced oxidative processes, which is viable for the quality control of scale inhibitor products in onshore and offshore installations. In said method, the phosphonate species are first converted into phosphate through the UV/persulfate process and, as the phosphate groups are not electroactive, they must be complexed with molybdate ions, forming the phosphomolybdenum complex, called Keggin anion, which is electrochemically detected. Additionally, the approach can also be applied to the analysis of phosphorus residuals in production water.

Additionally, the present disclosure proposes a system comprising a sample container, a UV lamp, a photolithographic working electrode (WE) made, preferably, in Au, but not limited to this metal, and can also be in C, Pt and Pd, for example. The electrically active region of the electrode is delimited by photolithography using a layer of epoxy resin (preferably SU-8, but not limited to this). It should be emphasized that the working electrode is not limited to those obtained by photolithography, and can be a disk and printed electrode, for example. Complementarily, the system further consists of a counter electrode (CE) and a reference electrode (RE), made of Pt or Au, and Ag/AgCl (saturated in KCl or paint), respectively, but not limited to these, which can be external or photolithographic electrodes delimited with resin, in addition to a potentiostat and equipment to control the same via an appropriate interface (cell phone, computer).

### BRIEF DESCRIPTION OF FIGURES

FIG. 1 shows the experimental apparatus used to convert the phosphonate sample into phosphate species by exposing the solution containing the oxidizing agent to the UV light (λ=254 nm) in a plastic container (preferably Teflon, but not limited to this material).

FIG. 2 shows the two types (A and B) of working electrodes (WE) used, with dimensions of 25 mm long by 10 mm wide, highlighting the delimitation of the electrode area with a layer of SU-8 epoxy resin. As for the counter electrodes (CE) and reference electrodes (RE), in the configuration (A), external electrodes, Pt wire (CE) and Ag/AgCl in KCl 3M (RE) were used. In the configuration (B), Au film (CE) and Ag/AgCl paint (RE) in the area delimited by SU-8 were used.

FIG. 3 shows the electrochemical results for the H₃PO₄ standard used to investigate the performance of the method through an analytical curve. In (A), average SWV (n=3) for the phosphomolybdenum complex at concentrations of 5.0-20.0 mg L⁻¹ phosphate. In (B), analytical curve obtained from SWV data, collected at a of +0.21 V, from 3 independent Au electrodes (n=3) for each phosphate concentration. CE: Pt wire and RE: Ag/AgCl in KCl 3M. [K₂S₂O₈]=27.0 μg L⁻¹.

FIG. 4 shows the electrochemical results for phosphonate standards (A) ATMP and (B) DTPMP in ‘s/UV’ and ‘c/UV’ conditions after 15 minutes of exposure to the UV light (5 W, λ=254 nm) in the presence of K₂S₂O₈. [K₂S₂O₈]=27.0 g L⁻¹. WE of Au (n=3 for each concentration), CE: Pt wire and RE: Ag/AgCl in KCl 3M.

FIG. 5 shows the average SWV sequence (n=3) of the phosphomolybdenum complex obtained for nine concentrations of the real sample ‘s/UV’ and ‘c/UV’ after 15 minutes of exposure to the UV light (5 W, λ=254 nm) in the presence of K₂S₂O₈. [K₂S₂O₈]=27.0 g L⁻¹. WE of Au (n=3 for each concentration), CE: Pt wire and RE: Ag/AgCl in KCl 3M.

### DETAILED DESCRIPTION OF THE DISCLOSURE

The present disclosure primarily refers to an electrochemical method for the indirect monitoring of the active matter of scale inhibitors, composed of phosphonates, based on principles of advanced oxidative processes, which is viable for the quality control of scale inhibitor products in onshore and offshore installations. The monitoring of wastewater samples containing phosphonate, as well as samples of phosphonate standards, such as, for example, H₃PO₃, ATMP (C₃H₁₂NO₉P₃) and DTPMP (C₉H₂₈N₃O₁₅P₅) also fit into this proposal. Said method comprises the following steps, described in detail below:
(a) Sample preparation;
(b) Electrochemical reading.

Additionally, the present disclosure refers to a system comprising a sample container, a UV lamp, a photolithographic working electrode (WE) made, preferably, in Au, but not limited to this metal, and may also be in C, Pt and Pd, for example. The electrically active region of the electrode is delimited by a layer of epoxy resin (preferably SU-8, but not limited to the same). The working electrode is not limited to photolithography and can be a disk and printed electrode, for example. The system further consists of a counter electrode (CE) and a reference electrode (RE), external or photolithographic, made of Pt or Au, and Ag/AgCl, respectively, but not limited to these, in addition to a potentiostat and equipment to control the same (cell phone, computer).

The proposed method and system are easy to use and offer simple sample preparation and portable configuration, providing an attractive strategy for an immediate solution to non-conformities in offshore installations.

### a) Sample Preparation

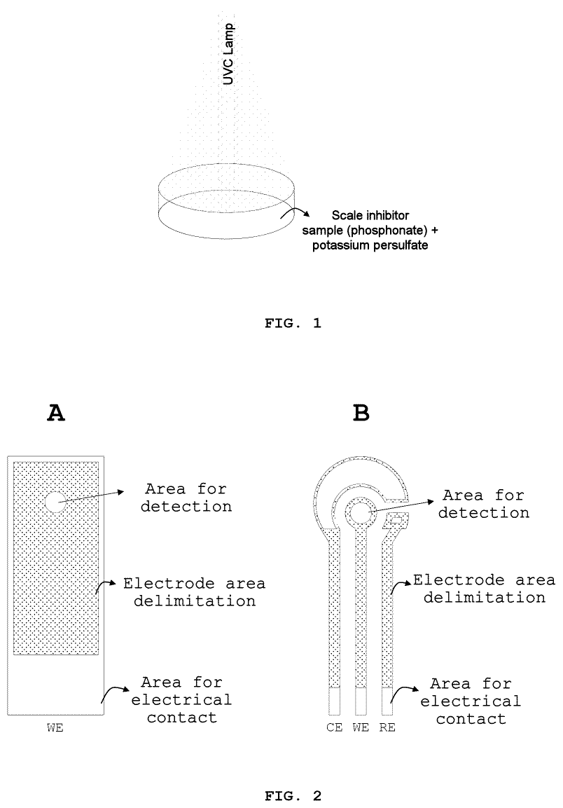

In the proposed electrochemical method, the active matter of the scale inhibitors must be exclusively phosphonate. However, phosphonate is not electroactive and, therefore, it is necessary to add a step to convert phosphonate to phosphate, based on advanced oxidative processes (LEE et al., 2020). The phosphonate-phosphate conversion, schematically represented in FIG. 1, was carried out by exposing the scale inhibitor sample (preferably diluted 1600 times, but not limited to this dilution factor) to the UV light (preferably λ=254 nm; power range: 5-13 W; time range: 3-15 min) in the presence of a strong oxidant (preferably potassium persulfate (K₂S₂O₈) with a concentration between 270.3 mg L⁻¹ and 27.0 g L⁻¹, (M A et al., 2017) but not limited to this, with sodium persulfate (Na₂S₂O₈) and hydrogen peroxide (H₂O₂) as options) (ZHANG et al., 2016). When the phosphonate concentration is previously known, as in the case of the samples of the standards mentioned above (H₃PO₃, C₃H₁₂NO₉P₃ and C₉H₂₈N₃O₁₅P₅), the solution preferably containing between 20 and 120 mg L⁻¹ of phosphonate, but not limited to this range of concentration, must be exposed to the UV light.

According to the degradation mechanism (WANG et al., 2019), when S₂O₈²⁻ species are exposed to the UV light, sulfate (SO₄^{•-}) and hydroxyl (OH^{•}) radicals are formed, cleaving the bonds of the phosphonate molecules, leading to the formation of phosphate in the form of phosphoric acid (H₃PO₄), which justifies the choice of this acid (H₃PO₄) to obtain the analytical curve. In this case, although the phosphoric acid used to construct the analytical curve (preferably in the concentration range of 0.0-20.0 ppm phosphate) does not have phosphonate groups, the same procedure for adding potassium persulfate (270.3 mg L⁻¹-27.0 g L⁻¹) and exposure to the UV light (preferably λ=254 nm; power range: 5-13 W; time range: 3-15 min) was carried out to maintain the experimental conditions of the samples. The description for constructing the analytical curve will be detailed in the step of ‘electrochemical reading’.

Like phosphonate, phosphate is also not electroactive and, therefore, for its electrochemical detection, it was necessary to complex the same with molybdate (preferably ammonium molybdate, but there are other options such as, for example, lithium molybdate (Li₂MoO₄) (ARVAS et al., 2018) and in situ oxidation of metallic molybdenum (BARUS et al., 2016)), forming the phosphomolybdenum complex (Keggin anion). To do this, an aliquot (preferably 100 μL, but not limited to this volume) of the sample exposed to the UV light (hereinafter referred to as c/UV) and an aliquot (preferably 100 μL, but not limited to this) of the sample not exposed to the UV light (named here as s/UV) were added to solutions (900 μL), previously prepared, containing, preferably, 49.0 g L⁻¹ of sulfuric acid (H₂SO₄), 16.0% v/v of acetone (C₃H₆O), and 3.7 g L⁻¹ of ammonium molybdate ((NH₄)₆Mo₇O₂₄·4H₂O), referred to as ‘blank’ solution.

The reaction for the formation of the complex depends on the properties of the solution, as neutral and basic media can compromise the conformation of the complex (BAJUK-BOGDANOVIĆ et al., 2016). A 10% decrease in the concentration of H₂SO₄, C₃H₆O and (NH₄)₆Mo₇O₂₄·4H₂O in the solution generated results similar to those obtained using the solution with the preferred concentrations. The formation of the phosphomolybdenum complex can be visually observed by a change in color, from transparent to light yellow, depending on the concentration of phosphate present in the medium. Soon after, the sample is ready for electrochemical measurements. It is important to note that, after electrochemical measurement of the sample, if the current value obtained is not within the current values obtained in the analytical curve, greater dilutions of the inhibitor exposed to the UV light with the ‘blank’ solution will be necessary.

### b) Electrochemical Reading

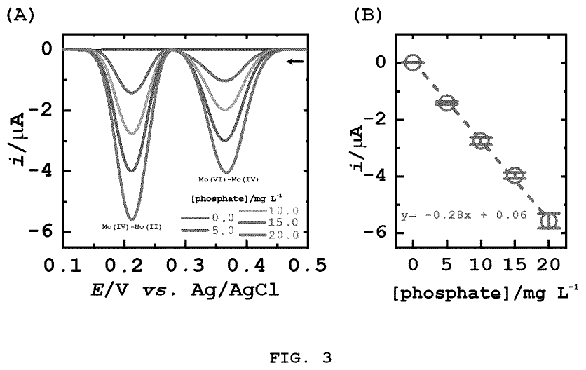

In the present disclosure, scalable photolithographic working electrodes were used, manufactured via thin film deposition preferably of Au, but not limited to this metal, and C, Pt and Pd may be used for example. The electrode manufacturing method is not limited to photolithography, and can be disk and printed electrodes, for example. In the present disclosure, a geometric area of 2 mm (preferably, but not limited to this area) was defined on the working electrode (WE) by means of the photolithographic pattern transfer using an epoxy resin (preferably SU-8, but not limited to this), ensuring greater reproducibility between electrodes (error less than ˜10%) and feasibility of mass production. FIG. 2 shows the two types of electrodes used. For electrochemical measurements, a counter electrode (CE) and reference electrode (RE), external or photolithographic, made of Pt or Au, and Ag/AgCl, respectively, were necessary, but not limited to these. For the photolithographic RE, Ag/AgCl ink was used in the area delimited by SU-8.

For electrochemical measurements, a sample volume (phosphomolybdenum complex) of 100 μL was sufficient to carry out, preferably, square wave voltammetry (SWV) tests on the working electrodes (WE). A portable potentiostat conducted the SWV analyses from +0.5 V to +0.1 V using external Ag/AgCl RE and SWV from +0.35 V to −0.3 V using Ag/AgCl paint RE. These potential ranges may vary depending on the type of RE used. The experimental parameters used were: step of −0.001 mV, amplitude of 25 mV and frequency of 10 Hz, but not limited to these parameters. Three independent measurements (n=3) were made for each sample on a new electrode, which was discarded after each measurement, since the phosphomolybdenum complex adsorbs on the WE surface (electrochemically irreversible).

The samples were analyzed electrochemically with (c/UV) and without (s/UV) UV conversion, always in the presence of a strong oxidant, because some samples may contain phosphate residues, making it necessary to correct the phosphate concentration obtained from the phosphonate-phosphate conversion, for the indirect determination of the concentration of phosphonate present in the sample.

To construct the analytical curve (current vs. concentration), the current value referring to the reduction peak of Mo(IV) to Mo(II) was used. A straight line equation was obtained and applied to determine the concentration of all samples c/UV and s/UV.

### Example of Embodiment

As mentioned, in the phosphonate-phosphate conversion mechanism, there is the formation of H₃PO₄, which was chosen as a standard to investigate the performance of the method by using an analytical curve. To maintain the experimental condition of the phosphonate-containing samples, K₂S₂O₈ at a concentration of 27.0 g L⁻¹ was added to the H₃PO₄ solution (120.0 mg L⁻¹) before its exposure to the UV light (5 W, λ=254 nm) for 15 minutes.

After obtaining the phosphomolybdenum complex from the exposed solution, dilutions were made to 5.0-20.0 mg L⁻¹ of phosphate using the ‘blank’ solution, which was also used to obtain curve 0.0 mg L⁻¹ phosphate. Measurements of SWVs were performed on three (n=3) new WEs for each concentration. FIG. 3A shows the average of these SWVs and is an example of the expected curve profile. The two reduction peaks at +0.38 and +0.21 V vs. Ag/AgCl correspond to reductions of Mo(VI)-Mo(IV) and Mo(IV)-Mo(II), respectively, the latter being chosen for the response of the method for indirect phosphonate quantification. It is important to mention that the position of the Mo reduction peaks may vary, depending on the used reference electrode.

From the resulting analytical curve, FIG. 3B, a linear trend was observed with a limit of detection (LOD) of 0.1 mg L⁻¹ of phosphate and analytical sensitivity (α) of −0.3 μA mg⁻¹ L. The LOD was calculated as 3σ/α, with σ being the standard deviation of the ‘blank’ solution. All results are presented as a function of the phosphate concentration.

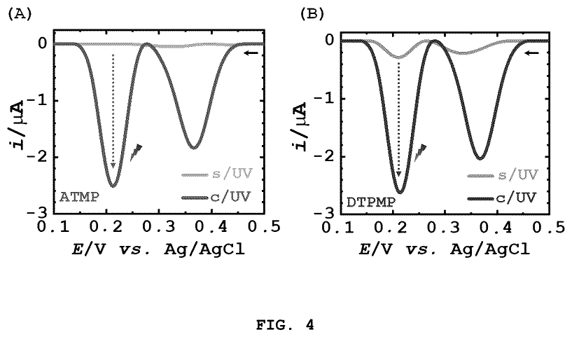

As a proof of concept, the phosphonate, ATMP and DTPMP standards were studied. Solutions of 120.0 mg L⁻¹ of ATMP (˜115.6 mg L⁻¹ of phosphonate) and DTPMP (100.5 mg L⁻¹ of phosphonate) containing 27.0 g L⁻¹ of K₂S₂O₈ were exposed to a UV light (5 W, λ=254 nm) for 15 min. Experiments using a higher power lamp (13 W, λ=254 nm) guaranteed a reduction in the sample exposure time to 3 min. As standards were used, the phosphonate concentration in each solution was known in advance. Then, considering that a phosphonate molecule is converted to a phosphate molecule (in a 1:1 ratio), after the phosphonate-phosphate conversion, samples were obtained with the phosphomolybdenum complex at a concentration of 10.0 mg L⁻¹ (concentration which is within the linear range of the analytical curve) of phosphate, which were monitored electrochemically. Mo reduction peaks (+0.21 V) were observed, FIG. 4, with smaller currents for the ‘s/UV’ condition. In the ‘c/UV’ condition, there was a significant increase in current for both standards, reaching values close to −2.50 μA. By subtracting the phosphate concentrations obtained under ‘c/UV’ conditions from the ‘s/UV’ conditions, the phosphonate concentration was indirectly obtained. Thus, when the recovery percentages were calculated, values of 83.0±2.7% were obtained for ATMP and 85.4±3.8% for DTPMP. These results were obtained using Au photolithographic electrode as WE, Pt wire as CE and Ag/AgCl as reference electrode.

To evaluate the applicability of the proposed method and system for the quality control of scale inhibitors using phosphonate as the active matter, exclusively, the electrodes were challenged with a real sample. In order to validate the results, the sample was first characterized by the nuclear magnetic resonance (NMR) technique, as seen in Table 1.

TABLE 1
Phosphonate species found in the real sample
through the analyses of the ¹H, ¹³C and ³¹P NMR spectra.

| | | | [Phosphonate |
|---|---|---|---|
| | Phosphonate | | species]ₜₒₜₐₗ |
| Sample | species | Other species | (g L⁻¹) |
| Real | DTPMP | 15.3 g L⁻¹ phosphate | 74.5 |
| sample | | 31.1% m/m monoethylene glycol | |
| | | 25.4% m/m ethanol | |

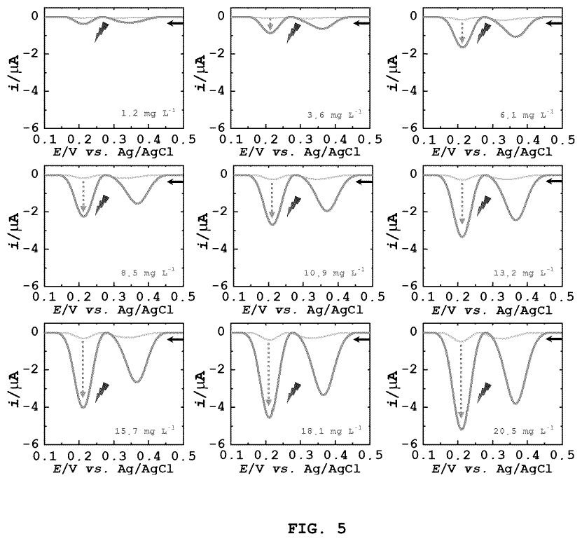

The NMR results revealed a mixture of phosphate species, ethanol, monoethylene glycol and DTPMP (target), whose phosphonate concentration was found to be 74.5 g L⁻¹. Nine solutions were prepared from the real sample (1.2 to 20.5 mg L⁻¹ phosphate, labeled as samples 1 to 9), using the 27.0 g L⁻¹ K₂S₂O₈ solution. SWVs were obtained for each solution in the ‘s/UV’ and ‘c/UV’ cases, FIG. 5. The determined and expected phosphonate concentrations (NMR) were compared, and an overall accuracy of 86.0±2.6% was obtained. The NMR result validated the data obtained in the present disclosure, which means that the method showed reliable accuracy.

Notwithstanding, although there is a commercial colorimetric kit dedicated to samples containing phosphonate, these face problems related to variations in refractive index and turbidity effects, unlike the proposed method and system, which still offer the advantages of more accurate and faster analyses, as they can be carried out immediately after exposure to the UV light, taking advantage of the instantaneous formation of the phosphomolybdenum complex, which certainly makes the same an alternative tool for quality control of scale inhibitors in onshore and offshore installations. This analysis will enable rapid decision-making to readjust the dose of inhibitor to be applied or corrected in the production lines. Additionally, the proposed method and system are not limited only to the quality of the scale inhibitors, but can also be applied to the determination of phosphorus residuals in production water.

### Application of the Disclosure

The proposed method and system were developed for in loco quality control of scale inhibitors (which have phosphonate groups as active matter) before they are injected into oil and gas production lines. As it is a portable system, it can be used on offshore and onshore oil platforms to determine the concentration of the active ingredient (phosphonate), thus making it possible to determine the quality of the received scale inhibitor. This analysis will enable rapid decision-making to readjust the dose to be applied or corrected in the production lines. Furthermore, the method is not limited only to the quality of the inputs, but can also be applied to the determination of phosphorus residuals in production waters.

### Advantages

### Reliability

From more efficient dosing and monitoring, there is greater reliability of combat systems and minimization of the scale, reducing stoppage and maintenance occurrences.

### Health/Safety

By minimizing the scale formation, equipment cleaning events are also reduced. With this, interventions on equipment are reduced, avoiding exposure and risks inherent to the activity.

### Economic/Productivity

Optimization of the dosage of scale inhibitors. Minimizing occurrences of scale and eventual stoppages of equipment for cleaning. Reduction of losses due to loss of profit due to production reduction or maintenance stoppage.

### BIBLIOGRAPHIC REFERENCES

Lee J., Von Gunten U., Kim JH. Persulfate-Based Advanced Oxidation: Critical Assessment of Opportunities and Roadblocks. Environ Sci Technol 2020; 54:3064-81. https://doi.org/10.1021/acs.est.9b07082.
Ma J., Yuan Y., Zhou T., Yuan D. Determination of total phosphorus in natural waters with a simple neutral digestion method using sodium persulfate. Limnol Oceanogr Methods 2017; 15:372-80. https://doi.org/10.1002/lom3.10165.
Zhang, X.; Guo, W.; Zheng Y.; Cheng, Z.; Qi, X.; Gao, C. Rapid determination of aminotris (methylenephosphonic acid) in water by ultraviolet photooxidation. Instrumentation Science & Technology 2016, 45:4, 459-468, DOI: 10.1080/10739149.2016.1255227
Wang, A.; Chen, G.; Patton, S.; Ren, C.; Liu, J.; Liu, H. Degradation of nitrilotris-methylenephosphonic acid (NTMP) antiscalant via persulfate photolysis: implications on desalination concentrate treatment. Water Research 2019, 159, 30-37.
Arvas, M. B.; Gursu, H.; Gengten, M.; Sahin, Y. Electrochemical formation of molybdenum phosphate on a pencil graphite electrode and its potential application for the detection of phosphate ions. Anal. Methods 2018, 10, 4282-4291.
Barus, C.; Romanytsia, I.; Striebig, N.; Garçon, V. Toward an in situ phosphate sensor in seawater using Square Wave Voltammetry. Talanta 2016, 160, 417-424, http://dx.doi.org/10.1016/j.talanta.2016.07.057i.
Bajuk-Bogdanović, D.; Uskoković-Marković, S.; Hercigonja, R.; Popa, A.; Holclajtner-Antunović, I. Study of the Decomposition Pathway of 12-Molybdophosphoric Acid in Aqueous Solutions by Micro Raman Spectroscopy. Spectrochimica Acta Part A: Molecular and Biomolecular Spectroscopy 2016, 153, 152-159. https://doi.org/10.1016/j.saa.2015.08.029.

1. An electrochemical method for the indirect monitoring of the active matter of scale inhibitors in onshore and offshore installations, the method comprising the following steps:
(a) sample preparation; and
(b) electrochemical reading, and
wherein the active matter of the scale inhibitors is composed of phosphonates that are converted into phosphate.

2. The method according to claim 1, wherein the phosphonate solutions, phosphonic acid (H₃PO₃), ATMP (C₃H₁₂NO₉P₃), and DTPMP (C₉H₂₈N₃O₁₅P₅), are converted into phosphate through an ultraviolet (UV) (/persulfate process, and wherein solutions containing a strong oxidant are exposed to UV light 5-13 W, λ=254 nm for 3-15 minutes.

3. The method according to claim 1, wherein after acidifying the solutions exposed to UV light with sulfuric acid, acetone and ammonium molybdate is added to generate the phosphomolybdenum complex, thereby to allow the electrochemical reading to be carried out.

4. The method according to claim 1, wherein for the electrochemical measurements on the working electrodes, the electrically active region is delimited by a layer of epoxy resin via a photolithographic method, whereby voltammetry tests are performed on a portable potentiostat.

5. An electrochemical system for the indirect monitoring of the active matter of scale inhibitors in onshore and offshore installations, the method comprising a sample container, a UV lamp, a working electrode (WE), a counter electrode (CE), a reference electrode (RE), a potentiostat and equipment to control the interface.

6. The electrochemical system according to claim 5, wherein the photolithographic working electrode (WE) comprises one or more of Au, C, Pt or Pd.

7. The electrochemical system according to claim 5, wherein the counter electrode (CE), external electrodes, Pt wire, and Au films are used, and, for the reference electrode (RE), photolithographic with Ag/AgCl ink, and external Ag/AgCl 3M electrodes are used.

8. The electrochemical system according to claim 5, wherein the electrically active region of the working electrode is delimited by photolithography, using a layer of epoxy resin.
